(19) United States
(12) Patent Application Publication
(10) Pub. No.: US 2003/0069933 A1
(43) Pub. Date: Apr. 10, 2003

(54) Electronic mail service system and method that make use of dynamic IP filtering technology

(76) Inventors: Sung-Yeop Lim, Seoul (KR); Woo-Joo Lee, Seoul (KR)

Correspondence Address: Robert E. Bushnell, Suite 300, 1522 K Street, N.W., Washington, DC, 20005, US

(21) Appl. No.: 10/193,260

(22) Filed: Jul. 12, 2002

(30) Foreign Application Priority Data
Oct. 6, 2001 (KR) 2001-61649
May 29, 2002 (KR) 2002-29828

(51) Int. Cl. G06F 15/16

(52) U.S. Cl. 709/206

(57) ABSTRACT

A connection request from a remote host is denied by an e-mail service system, if the number of connection request from the remote host exceeds a predetermined reference number, and the responsibility to re-send the denied e-mail is transferred to the requesting host. For the determination of connection permission or denial, the number of connection requests from the remote host is calculated with reference to corresponding to an IP address. By the IP filtering scheme, traffic of the e-mail service system can be effectively managed and controlled. The e-mail service system of the present invention includes a dynamic IP filtering module, a mail transfer agent (MTA), a receiving means for accepting a connection request from a remote host, a means for extracting an IP address corresponding to the requesting remote host according to an IP block, and a means for determining permission of connection by comparing a predetermined reference value with a summation value of the number of past requests made during a predetermined control time period and current request from the extracted IP address. The dynamic filtering module includes a means for resetting, before the determination of connection permission, a connection request number in a slice between previous connection time and current time.

### CLAIM OF PRIORITY

This application makes reference to, incorporates the same herein, and claims all benefits accruing under 35 U.S.C. §119 from my applications entitled ELECTRONIC MAIL SERVICE METHOD AND SYSTEM MAKING USE OF DYNAMIC IP FILTERING earlier filed with the Korean Industrial Property Office on Oct. 6, 2001 and there duly assigned Serial No. 2001-61649, and entitled ELECTRONIC MAIL SERVICE METHOD AND SYSTEM MAKING USE OF DYNAMIC IP FILTERING earlier filed with the Korean Industrial Property Office on May 29, 2002 and there duly assigned Serial No. 2002-29828.

### BACKGROUND OF THE INVENTION

1. Technical Field of the Invention

This invention relates generally to electronic mail service system and method, and more particularly to a dynamic IP (Internet Protocol) filtering technology that adopts a varying start time conception to continuously filter IP addresses, apply multiple IP filtering policies and implement various IP filtering policies to a single IP group according to time.

2. Description of Related Art

Distributed computer network such as the Internet is an increasing global communication for information exchange and dissemination, and peer-to-peer communication using an electronic mail (e-mail) system becomes one of daily business. The e-mail is a widely used network application in which text messages are transmitted electronically between end users over various types of networks using various network protocols. The e-mail system is a distributed client/server system having equivalent servers for providing e-mail services to the clients. The e-mail system is based on an open system where the clients communicate with the server to transmit and receive an e-mail message and the server communicates with other servers. This open nature exposes the problems of ever increasing UCE (Unsolicited Commercial E-mail) such as spam mails, junk mails, e-mail bombs and the like (referred to as ‘spam mail’).

Since the 1990s, with the rise in commercial awareness of the Internet, the spam mails are used to indiscriminately send large amounts of unsolicited e-mail messages for the purpose of commercial advertisement at lower cost. The spam mail becomes a serious threat to both the ISPs (Information Service Providers) and end users. The ISPs waste their system resources in dealing with the spam mails: network resources in transmitting spam messages of more than several gigabytes targeted to over hundreds of thousands of users; and additional communications costs and the loss of system and human resources in taking counter-measures, e.g., automatic returning of the spam mail to the sender and processing refusal or complaint messages from the spam recipients. Likewise, many receivers pay for the time to distinguish actual mails from spam mails which wastes computing resources.

Conventional methods to solve the spam mail threat include a recipient approach and an e-mail service provider approach. This server-based solution is a combination of a MTA (mail transfer agent) control technology and a contact regulation in which a spam sender is prohibited from using anonymous configurations and the relay of SMTP ((Simple Mail Transfer Protocol) is blocked.

Generally, traffic of a mail server in an ISP is 5 to 10 times more in receiving e-mail than in transmitting e-mail, and the spam mails amounts to about 60 to 80% of the receiving mail traffic. Many of the spammers hide behind false return addresses and deliberately write messages to mislead recipients. Therefore, the most reliable method to prevent the spam mail may be reading and reviewing one by one the titles and body texts of mail messages to determine if the mail is spam. However, this takes too much time and costs both to the ISPs and end users, and determination of spam mail is difficult since the criteria of the determination is subjective. Furthermore, if a spam e-mail is from an unknown source, there is a possibility that it may include a virus. Opening the individual mail to check if it is a spam may initiate a virus or other program that may harm the local computer.

Therefore, technical measures are needed on behalf of the Internet and e-mail communities to more effectively solve the problems of spam mails.

### SUMMARY OF THE INVENTION

An object of this invention is to minimize the loss of e-mail service providers due to spam mails.

Another object of this invention is to effectively maintain and control the traffic of the spam mails in the e-mail service providers and to prevent damages from the spam mails.

Yet another object of this invention is to provide an e-mail service system and method that can apply separate spam blocking policies to IP groups that request a connection to the system and can flexibly apply various IP filtering or blocking policies to a single IP group.

According to one aspect of the present invention, a connection request from a remote host is denied by an e-mail service system, if the number of connection requests from the remote host exceeds a predetermined reference number, and the responsibility to re-send the denied e-mail is transferred to the requesting host. For the determination of connection permission or denial, the number of connection requests from the remote host is calculated with reference to corresponding to an IP address. By the IP filtering scheme, traffic of the e-mail service system can be effectively managed and controlled.

The e-mail service system of the present invention includes a dynamic IP filtering module, a mail transfer agent (MTA), a receiving means for accepting a connection request from a remote host, a means for extracting an IP address corresponding to the requesting remote host according to is an IP block, and a means for determining permission of connection by comparing a predetermined reference value with a summation value of the number of past requests made during a predetermined control time period and current request from the extracted IP address. The dynamic filtering module includes a means for resetting, before the determination of connection permission, a connection number in a slice between previous connection time and current time.

In the e-mail service system of the present invention, a dynamic IP filtering method including the steps of: receiving a connection request from a remote host; searching an IP block and extracting an IP address corresponding to the requesting remote host from the IP block; determining a connection permission by comparing a predetermined reference value with a summation value of the number of past requests made during a predetermined control time period and current request from the extracted IP address; and resetting, before the determination step, a connection number in a slice between previous connection time and current time.

According to other aspects of the present invention, various IP filtering policies may be applied to different IP groups or to a single IP group according to time, so that the traffic within the e-mail service system can be controlled more effectively and the dynamic IP filtering technology is implemented more flexibly in diverse circumstances.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram of overall configuration of an electronic mail network according to the present invention;

FIG. 2 is a schematic diagram for showing IP blocks and recorders in an electronic mail service system of the present invention;

FIG. 3 is a flow chart of the processes of a dynamic IP addresses filtering method in the electronic mail service system;

FIG. 4 is a block diagram for showing multiple policy technology applied to different IP blocks with different IP blocking policies according to the present invention;

FIG. 5 is a block diagram for illustrating an embodiment in which different IP filtering policies are applied to a single IP group according to time; and

FIG. 6 is a block diagram of an e-mail service system implemented in a form of ASP (Application Service Provider).

### DETAILED DESCRIPTION OF PREFERRED EMBODIMENTS

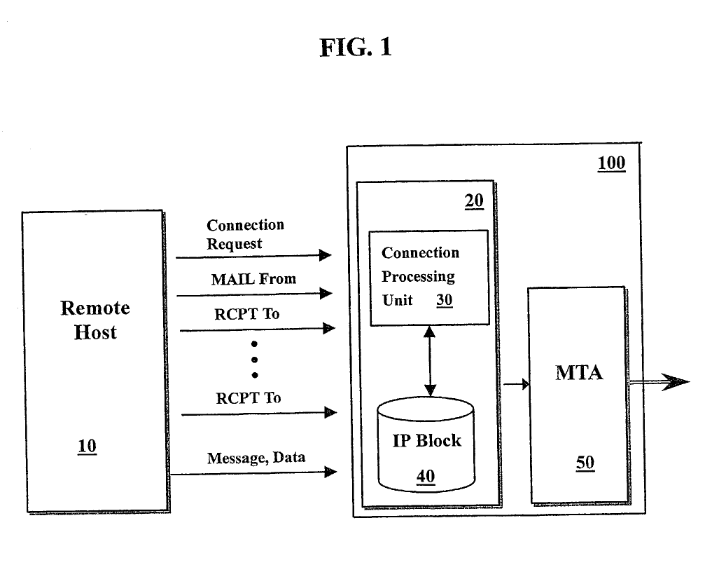

Turning now to the drawings, FIG. 1 shows a configuration of the electronic mail network according to the present invention. The e-mail network is a distributed computer system for generating, accessing, transmitting and receiving e-mail and based on protocols including but not limited to IMAP (Internet Messaging Access Protocol), POP (Post Office Protocol) and SMTP (Simple Mail Transfer Protocol).

A remote host 10 is connected to the e-mail service system 100 through a network including a public network such as the Internet and LAN (Local Area Network). The remote host 10 may be an individual user client system or include a server system equivalent to the e-mail service system 100. The network has plenty of connection nodes and communication is performed by using Internet Protocol (IP). The IP is widely known as a standard to communicate data. Upper layer protocols such as HTTP (HyperText Transfer Protocol) and FTP (File Transfer Protocol) communicate on an application layer, while lower layer protocols such as TCP/IP (Transmission Control Protocol/Internet Protocol) undertake communications on transport and network layers. Mail messages are sent to the address e.g. <receiver@terracetech.com> using the SMTP protocol.

The e-mail service system 100 includes one or more server computers and may configure a part of a private intranet connected to the public network. For security, the communications between the public network and private intranet may be filtered and controlled by a firewall. The firewall restricts outsiders from accessing to certain resources within the intranet. The server computer included in the e-mail service system 100 is configured to execute server software programs on behalf of the clients. The server computer is configured to maintain user accounts, to receive and organize mail messages so that they can readily be located and retrieved, no matter how the information in the message is encoded. The server computer may include a web server, CGI (Common Gateway Interface) programs, an account manager and SMTP mail server.

The e-mail service system 100 includes a dynamic IP address filtering module 20 and a mail transfer agent (MTA) 50 such as Sendmail™ and Qmail™. The MTA 50 includes a transfer MTA, a receiver MTA and a gateway MTA. The filtering module 20 includes a connection processing unit 30 and an IP block 40. The e-mail service system 100 receives new e-mail messages using e.g., POP-3 protocol from the remote host 10 and transmits e-mail messages by using e.g., SMTP (Simple Mail Transfer Protocol) or ESMTP (Extended SMTP) protocols.

The remote host 10 sends to the service system 100 a connection request and transfers to the service system 100 an e-mail message, a file to be attached to the message and data necessary for transmitting the e-mail messages e.g. MAIL From <spam@host.domain>, RCPT To <receiver@host.domain>. “MAIL From” includes a message to identify the e-mail address of the sender of the message and “RCPT To” includes a message to identify the address of an intended recipient of the message. The connection processing unit 30 of the dynamic IP address filtering module 20 determines a permission of connection to the request from the remote host 10 with reference to the IP block 40. If connection is permitted, data and message transmitted from the remote host 10 are delivered to the MTA 50 and transferred to the designated e-mail receiver or another remote host. The determination of the connection permission to the remote host 10 depends on the comparison result of reference value with the number of connection requests based on the IP address from a certain remote host, which will be explained in detail below.

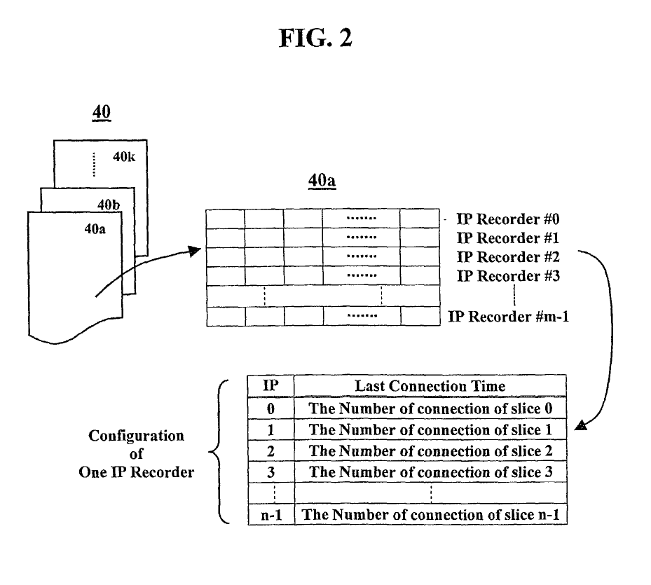

FIG. 2 is a conceptual diagram of configuration of the IP block and recorders in the e-mail service system according to the present invention. The IP block in the e-mail service system 100 is data stored in advance. When a remote host 10 requests a connection, an IP address associated to the remote host is recorded. The IP block 40 includes a plurality of IP groups 40a, 40b, . . . , 40k which are arranged according to a predetermined rule of IP address grouping. The connection processing unit 30, receiving the connection request from a remote host 10, searches and extracts from the IP block 40 an IP address corresponding to the requesting remote host. It is preferable to configure the IP block of IP addresses by using e.g. a hash function, so that the connection permission can be determined with respect to concurrent plural connection requests. A single IP group (e.g. 40a) includes a plurality of recorders (#0˜#m−1), and one recorder is formed to one IP address. Each of the recorders includes a number of slices, e.g. ‘n’ slices from ‘slice 0’ to ‘slice n−1’. The slice is a unit dividing the recorder based on time. In each of the slices, the number of connection request received from a certain remote host is recorded.

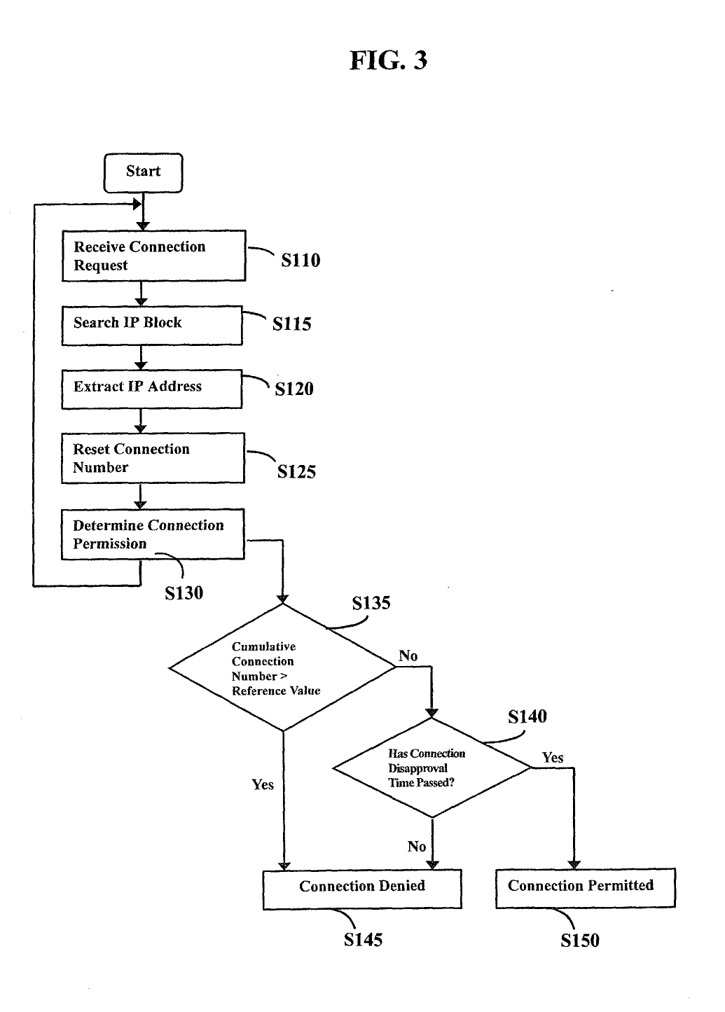

FIG. 3 shows the processing flow of the dynamic IP address filtering in an e-mail service system of the present invention.

A connection request from a remote host is received at step S110. An IP address of the requesting remote host is extracted at step S120 by searching the IP block at step S115. Permission of connection of the remote host is preliminarily determined at step S130 based on cumulative number of requests from the extracted IP address. The determination is made at step S135 by examining if the total summation of requests exceeds a reference value. Here, the total summation request is obtained by adding the current request and cumulative number of requests that are recorded in the slices corresponding to time ranging from the nearest past connection requesting time (i.e., the previous requesting time) to the current request to time retroactive to a predetermined control period. For instance, suppose that a single recorder has ten slices, these slices are controlled in ten-minute time units, the current request is received at 12:13, and the previous requesting time is 12:11. Among data recorded in the entire slices 0-9, the number of connections stored in slices 3-9 (i.e., slices corresponding to time between 12:03 to 12:10), the number of connections recorded in slice 0 (i.e., slice corresponding to time between 12:10 to 12:11) and the current connection request are summed to be the cumulative number of requests, and at step S135 the cumulative value is compared with the reference value. The reference value is determined by synthetically considering system resources of the e-mail service provider, dimension of users, and traffic and denoted as the number of requests per time.

If the cumulative connection number exceeds the reference value, the connection of the remote host corresponding to the associated IP address is denied at step S145. Even when the cumulative number of requests from a remote host does not exceed the reference value, it is determined that a connection disapproval time to the associated IP address has passed at step S140. When the connection disapproval time has not passed, the connection of the remote host corresponding to associated EP address is denied. If the connection disapproval time is passed or there have been no precedent cases to deny the connection, the connection is permitted at step S150 and e-mail message and data are transferred to the MTA 50 to carry out normal e-mail transmission process.

Prior to the determination of connection permission S130, the connection number is reset at step S125. The reset step of the connection number S125 resets the number of connections in slices between the previous connection time and current time to be ‘0’. In case of the example above, between slices corresponding to the previous requesting time 12:11 and the current time 12:13 there exists a slice to 12:02. This is because there is no connection between the previous connection time and current time and thus in this time interval connection number data is recorded in slice(s) corresponding to past time prior to time retroactive to the slice control time (in this instance ten minutes). Accordingly, the connection time data stored in the past slice is reset to ‘0’ so that the control time can be maintained as a continuous time value.

After the determination step of connection permission S130, the sequence flows back to the receiving step of new connection request S110. It may be considered to memory (or store) the IP address to which the connection is permitted and to omit the searching IP block to the identical IP address. However, in view of system resources to memory or store the IP address data in connection with the connection permission, it is preferable to search the IP block and extract the corresponding IP address whenever a connection is requested.

According to the dynamic IP filtering technique of the present invention, multiple time policies can be applied to a single data structure.

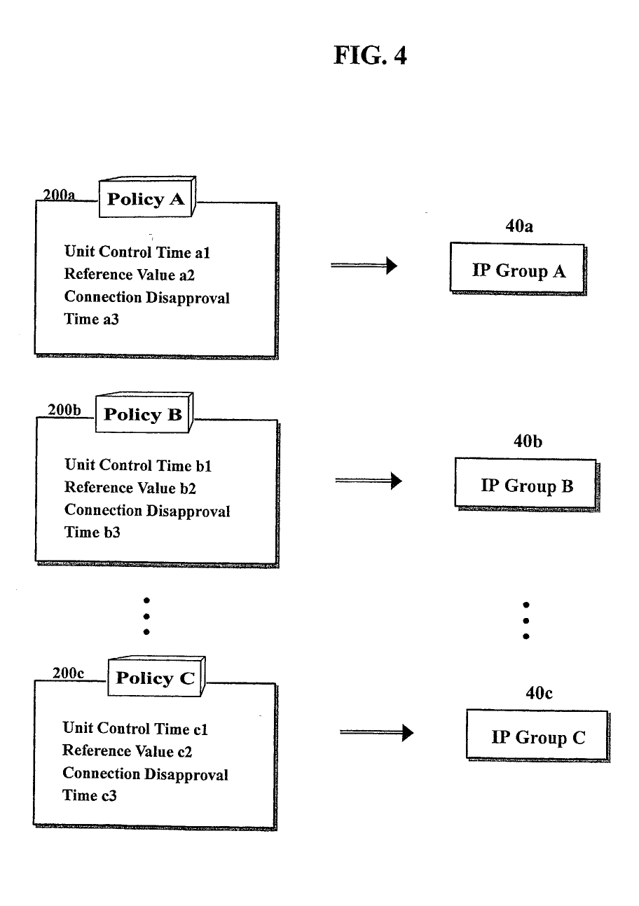

FIG. 4 is a block diagram illustrating the multiple time policies by which different policies are applied to each of the plurality of IP blocks. IP filtering policy A 200a applied to IP group A 40a has different unit control time, reference value and connection disapproval time from those of policies B and C 200b and 200c. At this time, the ‘unit control time’ means the period of time used for summing the requested number at step 135 of FIG. 3, and the ‘reference value’ refers the reference number compared with the summation of cumulative number of request during the unit control time and the current request. The multiple IP filtering policy has, for instance, the unit control time a1 of one hour, the reference value 12 of 10 times, and the connection disapproval time a3 of two hours to an IP group A 40a having IP addresses from 210.220.10.0 to 20.220.250.255, while an IP group B 40b of IP addresses ranging from 210.0.10.0 to 210.220.0.0 is subject to IP filtering policy B 200b which has the unit control time b1 of ten minutes, the reference value b2 of 10 times, and the connection disapproval time b3 of thirty minutes. In the multiple IP filtering policy, a default policy may be applied to IP groups that does not need a special policy. When it is required to confirm if a certain IP address is to be blocked, parameters in associated IP filtering policy to the IP group including the certain IP address may be called and read. The policy parameters (e.g., unit control time, reference value, and connection disapproval time) are applied to the associated IP filtering policy and calculated.

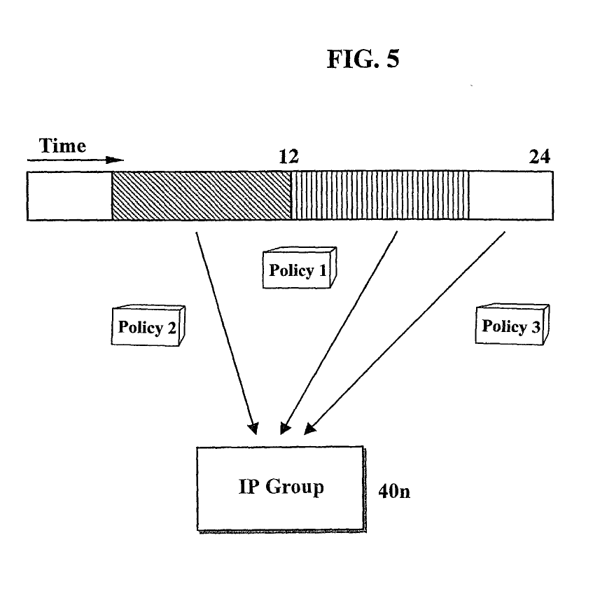

According to the present invention, as shown in FIG. 5, different policies may be applied to a single IP group 40n according to time. By doing this, it is possible to apply dynamically and flexibly a specially reinforced policy to a certain time period when requests for spam mails are peak and thus more efficient management of server traffic is made possible.

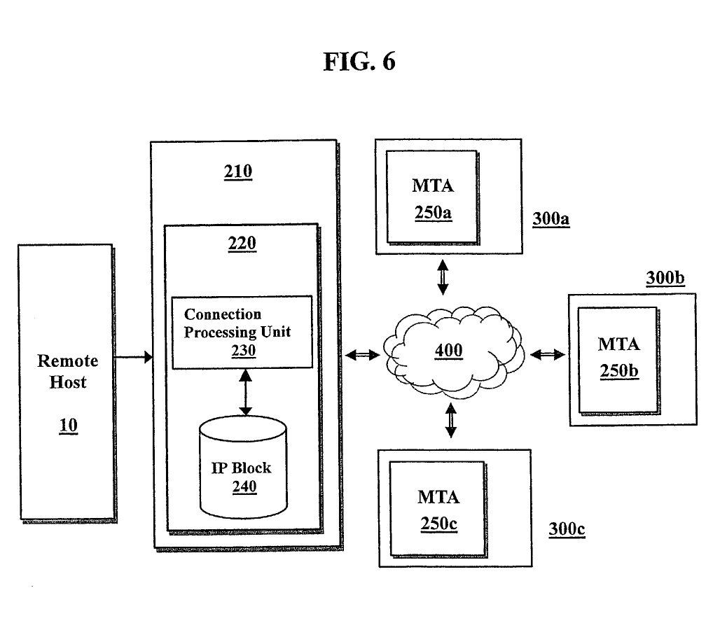

FIG. 6 is a block diagram of an e-mail service system implemented in a form of ASP (Application Service Provider). The e-mail service system 210 receives a connection request, a signal necessary for transmission of e-mail message, an e-mail message and file attached to the message, and the dynamic IP filtering module 220 determines the permission of connection to the request from a remote host 10. When the connection is permitted, the e-mail service system 210 transfers the e-mail message and necessary data to a plurality of remote servers 300a, 300b and 300c interconnected via a communication network 400. The dynamic IP filtering module 220 includes, like the system 100 of FIG. 1, a connection processing unit 230 and an IP block 240. The remote servers 300a, 300b and 300c have their own MTA 250a, 250b and 250c, respectively, which may include a transfer MTA, receiving MTA and gateway MTA.

In the ASP implementation of the e-mail service system of the present invention, each of the remote servers 300a, 300b and 300c can utilize outside resources of IP filtering module and thus can save their own system resource.

In the drawings and specification, there have been disclosed typical preferred embodiments of this invention and, although specific terms are employed, they are used in a generic and descriptive sense only and not for purposes of limitation. There may be other embodiments of this invention which are not specifically illustrated, and the scope of this invention is set forth in the following claims.

What is claimed is:

1. An e-mail service system, comprising:
means for receiving a connection request from a remote host;
means for extracting an Internet protocol address corresponding to the requesting remote host according to an Internet protocol block;
means for determining permission of connection by comparing a predetermined reference value with a summation value of the number of past requests made during a predetermined control time period and current request from the extracted Internet protocol address, the predetermined control time period is divided into a number of slices; and
a dynamic filtering module including means for resetting, before the determination of connection permission, a connection request number in a slice between previous connection time and current time.

2. The e-mail service system of claim 1, wherein a connection disapproval time is established to the Internet protocol address when the determination means denies the connection, and the connection of the Internet protocol address is blocked until the connection disapproval time passes.

3. The e-mail service system of claim 2, wherein the Internet protocol block includes a plurality of Internet protocol groups and an Internet protocol filtering policy applied to an Internet protocol group is different from the Internet protocol filtering policy applied to other Internet protocol groups, said Internet protocol filtering policy includes data for the predetermined control time, the reference value and the connection disapproval time.

4. The e-mail service system of claim 2, wherein the Internet protocol block includes a plurality of Internet protocol groups, and a plurality of Internet protocol filtering policies are applied to a single Internet protocol group, said policy including said predetermined control time period, said predetermined reference value and parameters related to the connection disapproval time.

5. An e-mail service system including a dynamic Internet protocol filtering module and interconnected to a plurality of remote servers via a communication network, each one of said remote servers including a mail transfer agent, said e-mail service system comprising:
means for receiving a connection request to the plurality of remote servers from a remote host;
means for extracting an Internet protocol address corresponding to the requesting remote host according to an Internet protocol block;
means for determining permission of connection by comparing a predetermined reference value with a summation value of the number of past requests made during a predetermined control time period and current request from the extracted Internet protocol address, the predetermined control time period is divided into a number of slices;
said dynamic Internet protocol filtering module including means for resetting, before the determination of connection permission, a connection request number in a slice between previous connection time and current time; and
means for transferring to a corresponding remote server an e-mail to which a connection is permitted by the determination means.

6. The e-mail service system of claim 5, wherein a connection disapproval time is established to the Internet protocol address when the determination means denies the connection, and the connection of the Internet protocol address is blocked until the connection disapproval time passes.

7. In an e-mail service system, a method for dynamically filtering an Internet protocol address comprising the steps of:
receiving a connection request from a remote host;
searching an Internet protocol block and extracting an Internet protocol address corresponding to the requesting remote host from the Internet protocol block;
determining a connection permission by comparing a predetermined reference value with a summation value of the number of past requests made during a predetermined control time period and current request from the extracted Internet protocol address, the predetermined control time period is divided into a number of slices; and
resetting, before the determination step, a connection request number in a slice between previous connection time and current time.

8. The method of claim 7, further comprised of a connection disapproval time being established to the Internet protocol address when the connection is denied according to said step of determining a connection permission, and the connection of the Internet protocol address is blocked until the connection disapproval time passes.

9. The method of claim 7, wherein the Internet protocol block including recorders each corresponding to one Internet protocol address, each of the recorders comprises a plurality of slices continuously managed according to the predetermined control time period, and to each of the recorders is written the number of connection request from the corresponding Internet protocol address.

10. The method of claim 8, wherein the Internet protocol block including recorders each corresponding to one Internet protocol address, each of the recorders comprises a plurality of slices continuously managed according to the predetermined control time period, and to each of the recorders is written the number of connection request from the corresponding Internet protocol address.

11. The method of claim 7, wherein, after the determination step of the connection permission, the sequence returns to the step of receiving a connection request from a remote host.

12. The method of claim 8, wherein, after the determination step of the connection permission, the sequence returns to the step of receiving a connection request from a remote host.

13. The method of claim 8, wherein the Internet protocol block includes a plurality of Internet protocol groups and an Internet protocol filtering policy applied to an Internet protocol group is different from an Internet protocol filtering policy applied to other Internet protocol group, said Internet protocol filtering policy including the predetermined control time period, the predetermined reference value and parameters related to the connection disapproval time.

14. The method of claim 8, wherein the Internet protocol block includes a plurality of Internet protocol groups and a plurality of Internet protocol filtering policies are applied to an Internet protocol group, said Internet protocol filtering policy including the predetermined control time period, the predetermined reference value and parameters related to the connection disapproval time.

15. In an e-mail service system connected to a plurality of remote servers, each one of the plurality of remote servers including a separate mail transfer agent, a method for dynamically filtering an Internet protocol address comprising the steps of:
receiving a connection request to the plurality of remote servers from a remote host;
searching an Internet protocol block and extracting an Internet protocol address corresponding to the requesting remote host from the Internet protocol block;
determining a connection permission by comparing a predetermined reference value with a summation value of the number of past requests made during a predetermined control time period and current request from the extracted Internet protocol address, the predetermined control time period is divided into a number of slices;
resetting, before the determination step, a connection request number in a slice between previous connection time and current time; and
transferring an e-mail associated with the remote host to which the connection is permitted at the step of determination to the corresponding remote server.

16. The method of claim 15, wherein a connection disapproval time is established to the Internet protocol address when the connection is denied, and the connection of the Internet protocol address is blocked until the connection disapproval time passes.

17. A method, comprising:
receiving a connection request from a remote host;
determining an Internet protocol address corresponding to the requesting remote host;
resetting a number of connection requests in slices between a previous connection time and a current connection time; and
determining a connection permission by comparing a predetermined reference value with a summation value of the number of past requests made during a predetermined control time period and current request from the determined Internet protocol address, the predetermined control time period being divided into a number of slices.

18. The method of claim 17, said predetermined reference value being set according to the system resources of the electronic mail service provider, dimension of users, and network traffic.

19. The method of claim 17, further comprised of a connection disapproval time being established to the Internet protocol address when the connection is denied according to said step of determining a connection permission, and the connection of the Internet protocol address is blocked until the connection disapproval time passes.

20. The method of claim 19, said step of determining an Internet protocol address corresponding to the requesting remote host being from the Internet protocol block, the Internet protocol block including recorders each corresponding to one Internet protocol address, each of the recorders comprises a plurality of slices continuously managed according to the predetermined control time period, and to each of the recorders is written the number of connection request from the corresponding Internet protocol address.

21. The method of claim 20, further comprising a sequence of said method returning to the step of receiving a connection request from a remote host after the determination step of the connection permission.

22. The method of claim 21, with the Internet protocol block including a plurality of Internet protocol groups and an Internet protocol filtering policy applied to an Internet protocol group being different from an Internet protocol filtering policy applied to other Internet protocol groups, said Internet protocol filtering policy including the predetermined control time period, the predetermined reference value and parameters related to the connection disapproval time.

23. The method of claim 21, with the Internet protocol block including a plurality of Internet protocol groups and a plurality of Internet protocol filtering policies being applied to an Internet protocol group, said Internet protocol filtering policy including the predetermined control time period, the predetermined reference value and parameters related to the connection disapproval time.
